(19) United States
(12) Patent Application Publication
(10) Pub. No.: US 2026/0211089 A1
(43) Pub. Date: Jul. 23, 2026

(54) IMAGING SENSOR AND IMAGING METHOD

(71) Applicant: Sony Semiconductor Solutions Corporation, Kanagawa (JP)

(72) Inventors: Francescopaolo MATTIOLI DELLA ROCCA, Stuttgart (DE); Daniele GIORGETTI, Stuttgart (DE); Matteo PERENZONI, Stuttgart (DE); Daniele PERENZONI, Stuttgart (DE); David STOPPA, Stuttgart (DE)

(73) Assignee: Sony Semiconductor Solutions Corporation, Kanagawa (JP)

(21) Appl. No.: 19/138,677

(22) PCT Filed: Dec. 14, 2023
(86) PCT No.: PCT/EP2023/085898

§ 371 Date: Jun. 13, 2025

(30) Foreign Application Priority Data
Dec. 22, 2022 (EP) 22215978.2

(51) Int. Cl. G01S 7/4865; G01S 7/486; G01S 17/10; G01S 17/894; G01S 17/931; H04N 25/533; H04N 25/773

(52) U.S. Cl. CPC G01S 7/4865; G01S 7/4868; G01S 17/10; G01S 17/894; G01S 17/931; H04N 25/533; H04N 25/773

(57) ABSTRACT

The disclosure pertains to an imaging sensor that includes a photosensitive element. The photosensitive element is configured to integrate incident light and stop the integration of incident light when a signal is detected in the incident light integrated by the photosensitive element.

### TECHNICAL FIELD

The present disclosure generally pertains to an imaging sensor and an imaging method.

### TECHNICAL BACKGROUND

It is generally known to perform imaging with an imaging sensor. For example, direct time-of-flight (DTOF) includes emitting light into a scene, imaging the scene by detecting single photons from the scene with each of a plurality of pixels of an imaging sensor, and generating a histogram for each pixel of the plurality of pixels.

The histogram indicates a count of single photons detected by the pixel for each of a plurality of time intervals. Photons that correspond to a reflection of the emitted light are represented by a peak in the histogram. A position (time interval) of the peak indicates a distance of an object in the scene that has reflected the emitted light.

Although there exist techniques for performing imaging, it is generally desirable to provide an improved imaging sensor and imaging method.

### SUMMARY

According to a first aspect, the disclosure provides an imaging sensor that includes: a photosensitive element configured to integrate incident light and stop the integration of incident light when a signal is detected in the incident light integrated by the photosensitive element.

According to a second aspect, the disclosure provides an imaging method for imaging with an imaging sensor, wherein the imaging method includes: integrating incident light; and stopping the integration of incident light when a signal is detected in the integrated incident light.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates a pixel array that integrates incident light from a scene;

FIG. 2 shows a block diagram of an imaging sensor according to an embodiment;

FIG. 3 illustrates a pixel duty cycle according to an embodiment;

FIG. 4 illustrates a flow diagram of an imaging method according to an embodiment;

FIG. 5 illustrates an embodiment of a smartphone and of smart glasses;

FIG. 6 illustrates an embodiment of a general-purpose computer;

FIG. 7 is a block diagram depicting an example of schematic configuration of a vehicle control system; and

FIG. 8 is a diagram of assistance in explaining an example of installation positions of an outside-vehicle information detecting section and an imaging section.

### DETAILED DESCRIPTION OF EMBODIMENTS

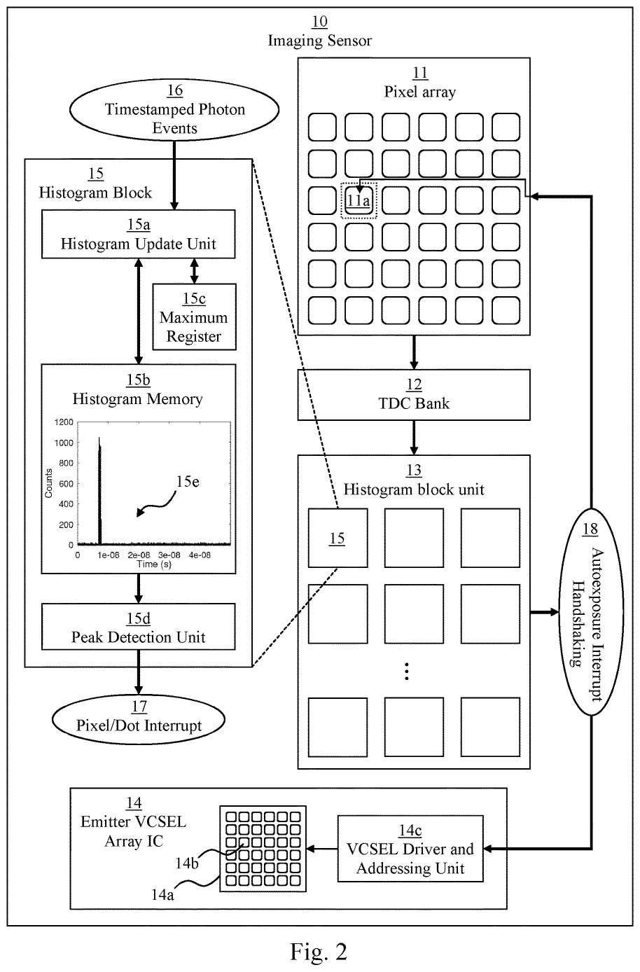

Before a detailed description of the embodiments under reference of FIG. 2 is given, general explanations are made.

As mentioned in the outset, it is generally known to perform imaging with an imaging sensor. For example, direct time-of-flight (DTOF) includes emitting light into a scene, imaging the scene by detecting single photons from the scene with each of a plurality of pixels of an imaging sensor, and generating a histogram for each pixel of the plurality of pixels.

The histogram indicates a count of single photons detected by the pixel for each of a plurality of time intervals. Photons that correspond to a reflection of the emitted light are represented by a peak in the histogram. A position (time interval) of the peak indicates a distance of an object in the scene that has reflected the emitted light.

For example, the emitting of light into the scene may include repeatedly emitting laser pulses into the scene, and the imaging may include counting, for each detected single photon, a time that has elapsed since the last emitted laser pulse. The emitted light may, for example, be generated by a vertical-cavity surface-emitting laser (VCSEL) or an array of VCSELs.

In some instances, in state-of-the-art image sensors, an exposure (i.e., a time during which pixels acquire light to capture a scene) is set globally, which means that all pixels of a pixel array of an image sensor integrate for a same time duration independent of a light level reaching each pixel. This may represent an issue for dynamic range and power consumption as pixels with a high light level may integrate for much longer than required in order to allow pixels with a low light level to accumulate enough signal over the noise floor.

In some instances, this can cause saturation of pixels with a high light level and can be solved by a known multiple exposure solution, where a whole pixel array of an image sensor is exposed multiple times with different global exposure durations to suit a variety of signal conditions. In some instances, however, this solution is power and resource inefficient as each image needs to be constructed from acquiring multiple images and all pixels are operating for all exposures for the full integration time.

In some instances, in a direct time-of-flight (DTOF) system, this problem may also be extended to a VCSEL array transmitter which drives all VCSELs with a same duty cycle regardless of a signal and background captured by the corresponding pixels at a receiver.

For example, in some instances, DTOF image sensors integrate both signal light and background light photons during exposure into a histogram that represents a time of arrival with respect to an emission time of a laser pulse from a transmitter, wherein the signal light corresponds to a reflection of the laser pulse from a scene. A distance measurement is encoded in a temporal position of a peak in the histogram. A number of laser cycles (laser pulses) required to measure the position of the peak in the histogram with adequate precision depends on a level of the background light (rate) and on a return (signal) light level (rate).

An integration time (the exposure) is, in some instances, set to favor a worst-case pixel condition, e.g., the pixel seeing a highest background level and lowest signal return rate (or a return rate at furthest distance or lowest target reflectivity). Such pixels with a worst-case pixel condition require, in some instances, a long integration time for a signal peak (the peak in the histogram) to be detected over a background photon shot noise.

This is, in some instances, in contrast to pixels focused on regions of the scene with low background and high return signal rates (or a short distance and high target reflectivity), which require fewer laser repetitions (shorter exposure) to be able to identify the position of peak in the histogram that corresponds to the return laser.

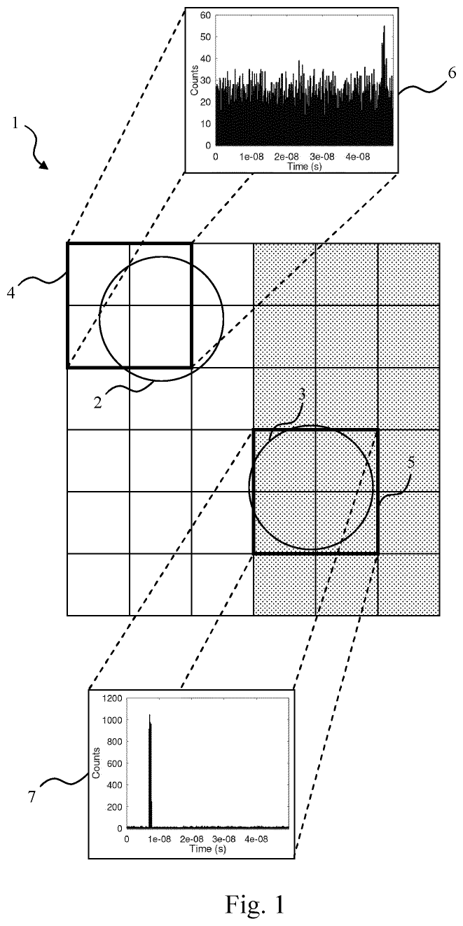

For example, FIG. 1 illustrates a pixel array 1 that integrates incident light from a scene. The pixels in the pixel array 1 perform timestamped photon counting. A left half (white background) of the pixel array 1 corresponds to a first object in the scene that is further away from the pixel array 1 than a second object to which corresponds a right half (dotted background) of the pixel array 1. A first laser dot 2 is emitted by a first VCSEL and illuminates the first object that is further away, and a second laser dot 3 is emitted by a second VCSEL and illuminates the second object.

Pixels in a first group 4 of pixels receive signal light that corresponds to the first laser dot 2, and pixels in a second group 5 of pixels receive signal light that corresponds to the second laser dot 3. Since the first object is further away from the pixel array 1 than the second object, the pixels in the first group 4 of pixels receive less signal light and have a lower signal-to-background ratio (SBR) than the pixels in the second group 5 of pixels.

The histogram 6 shows timestamped photon counts of the pixels in the first group 4 of pixels, and the histogram 7 shows timestamped photon counts of the pixels in the second group 5 of pixels. I.e., the histograms 6 and 7 show timestamped photon counts of not only a single pixel but of all pixels in the first and second group 4 and 5 of pixels, respectively. The histogram 6 shows a peak at a later time (corresponding to the further distance of the first object) and with a lower SBR than the histogram 7.

Although the peak in the histogram 7 with a higher SBR is detectable after a much shorter exposure than shown in FIG. 1, the pixels of the second group 5 keep integrating, due to the global exposure, for a much longer time than necessary for detecting the peak in the histogram 7 in order to allow the pixels of the first group 4 of pixels integrate enough light for detecting the peak in the histogram 6.

Although different pixels ideally require different exposures in some embodiments, there has previously been no solution for state-of-the-art image sensors to set the exposure of each pixel individually. In some instances, an integration time of pixels with a high signal-to-background ratio (SBR) is set to a same duration that allows pixels under worst-case background and signal conditions to identify the peak in the histogram. In some instances, this introduces a power inefficiency where all pixels of a pixel array of an image sensor are kept integrating until an end of the exposure, while pixels that detect a peak early and a corresponding emitter dot could be disabled, which could result in a power saving on both an emitter and a receiver.

In some embodiments of the present disclosure, it is detected at which point in time the signal received at any one pixel is enough to stop operating that specific pixel and a corresponding emitter VCSEL. In some embodiments, this requires a mechanism for an auto-exposure of a pixel and a VCSEL dot which can operate on each pixel individually and set an ideal integration time for each pixel and its corresponding VCSEL dot to collect a right amount of signal and thereafter, in case of a DTOF sensor, to compute a distance to a scene at each pixel.

Therefore, in some embodiments, an architecture and acquisition scheme for DTOF image sensors implements pixel-wise and dot-wise auto-exposure that can detect in real-time, e.g., during acquisition, when a pixel has integrated long enough to be able to extract a distance measurement from a received light signal. In some embodiments, a pixel/pixels of a pixel array of a DTOF image sensor identified as being ready for peak extraction and distance computation and its/their corresponding emitter dot are disabled immediately, whereas a rest of the pixels of the pixel array that have not yet accumulated enough signal for a precise distance measurement continue integrating until a peak is identified in their respective histograms and they are stopped by the auto-exposure scheme, or they are integrated until they reach a set global exposure upper limit.

Consequently, some embodiments of the present disclosure pertain to an imaging sensor that includes a photosensitive element configured to integrate incident light and stop the integration of incident light when a signal is detected in the incident light integrated by the photosensitive element.

For example, the imaging sensor may include a direct time-of-flight (DTOF) imaging sensor for determining a distance of an object in a scene by measuring a roundtrip time of a light signal.

The imaging sensor may include a pixel array that includes one or more pixels. The photosensitive element may be included in a pixel of the pixel array. The photosensitive element may be configured to convert incident light into an electrical signal.

The imaging sensor may further include an optical element, e.g., a lens and/or a mirror, for focusing the incident light on the pixel array such that each pixel of the pixel array may correspond to a predetermined region of a scene from which the incident light is received, e.g., each pixel may correspond to a portion of the scene from which the pixel receives light under a respective angle or solid angle.

The integrating of incident light may include generating an electrical signal that corresponds to the incident light. The stopping of the integration of incident light may include stopping generating an electrical signal that corresponds to the incident light. The stopping of the integration of incident light may also include reducing a voltage supplied to the photosensitive element, such that the incident light does not generate an electrical charge anymore and/or such that the photosensitive element does not generate the electrical signal that corresponds to the incident light anymore.

For example, the photosensitive element may consume less electrical power when the integration of incident light is stopped.

For example, the photosensitive element may receive a control signal which indicates that a signal is detected in the incident light integrated by the photosensitive element. For example, the photosensitive element may be configured to stop integrating incident light when a supply voltage of the photosensitive element is reduced.

For example, the integration of incident light may correspond to an exposure (integration time) of the photosensitive element, and the stopping of the integration of incident light may correspond to an end of the exposure.

For example, the signal may be detected in the integrated incident light if a signal-to-noise ratio (SNR) and/or a signal-to-background ratio (SBR) of the signal is high enough, e.g., higher than a threshold; i.e., the signal may be detected if a distinction between the signal and a background signal or noise signal is possible. A threshold for detecting the signal may be fixed or may be adaptive.

In some embodiments, the imaging sensor further includes a light emission unit configured to emit a light signal into a scene; the incident light includes light reflected from the scene; and the detected signal corresponds to a reflection of the light signal from the scene.

For example, the light emission unit may include a vertical-cavity surface-emitting laser (VCSEL) that emits the light signal into the scene. The light signal may have a predetermined wavelength or wavelength band, for example, the light signal may include infrared light, visible light and/or ultraviolet light. A filter may be provided in front of the photosensitive element for reducing (e.g., absorbing) a number of photons that have another wavelength than the predetermined wavelength (band) such that a percentage of photons with the predetermined wavelength (band) in the incident light may be increased and a risk of interference with another light source may be reduced.

The light signal may, for example, include a laser dot. The VCSEL may emit the laser dot into a predetermined direction, e.g., into a direction from which the photosensitive element receives incident light. Therefore, a reflection caused by the light signal in the scene (e.g., at an object in the scene) may be received by the photosensitive element.

The light signal may be temporally modulated. For example, the light signal may include a laser pulse or a series of laser pulses. The temporal modulation of the light signal may allow determining a time elapsed between emitting the light signal (e.g., a laser pulse) into the scene and receiving the detected signal in the incident light from the scene.

Repeatedly emitting the laser pulse into the scene and integrating incident light after each emitted laser pulse may increase an amount of integrated incident light and may increase a SNR and/or a SBR of the signal in the integrated incident light.

The imaging sensor may include a plurality of VCSELs (e.g., an array of VCSELs), wherein each VCSEL of the plurality of VCSELs may illuminate another portion of the scene and its reflection may be received by another pixel of the imaging sensor.

The imaging sensor may include a sparse amount of laser dots (VCSELs), e.g., each laser dot may correspond to a single pixel of the imaging sensor or to several pixels of the imaging sensor. A mapping which pixel receives which laser dot may be predetermined, e.g., based on a direction in which the respective laser dots are emitted and on a (solid) angle from which the respective pixels receive incident light. A mapping which pixel receives which laser dot may be dynamically determined, e.g., based on an initial scan on pixels before starting a distance measurement, on a precalibration and/or on an intensity mapping.

Although embodiments with a laser dot have been described above, the present disclosure is not limited to a laser dot. For example, in some embodiments, the light emission unit may include a light-emitting diode (LED) or a VCSEL whose emitted light is widened (e.g., by one or more lenses) such that the light signal emitted into the scene includes a homogeneous light cone that illuminates a larger portion of the scene than a laser dot, and whose reflection from the scene is received by a larger number of pixels than for a laser dot.

In some embodiments, the light emission unit is further configured to stop emitting the light signal when the signal is detected in the incident light integrated by the photosensitive element.

For example, when the photosensitive element stops integrating incident light, a reflection of the light signal may not be received by the photosensitive element anymore, and electrical energy may be saved by not emitting the light signal anymore.

In embodiments where a reflection of the light signal emitted by the light emission unit is received by a plurality of pixels of the imaging sensor, the light emission unit may stop emitting the light signal when a signal is detected in integrated incident light of photosensitive elements of all pixels of the plurality of pixels that receive a reflection of the light signal emitted by the light emission unit. I.e., the light emission unit may continue emitting the light signal as long as there is a pixel, among the plurality of pixels that receive a reflection of the light signal emitted by the light emission unit, for which a signal is not detected in incident light integrated in a photosensitive element of the pixel.

In some embodiments, the integration includes detecting single photons of the incident light; and the signal is detected based on timestamps of detection of the single photons.

For example, the photosensitive element may include a single-photon avalanche diode (SPAD), an analog or digital silicon photomultiplier (SiPM) and/or any other suitable photon counter.

The photosensitive element may be configured as a timestamped photon counter for time-correlated photon counting. For example, the photosensitive element may determine a timestamp of each counted single photon. The timestamp may indicate a point in time at which the photosensitive element has received or counted the single photon. The timestamp may indicate the time relative to the light signal emitted by the light emission unit, e.g., a duration that has elapsed since a last laser pulse emitted by the light emission unit. The photosensitive element may generate and output a photon event that indicates the detection of the photon.

For example, the photosensitive element may provide the photon event to a time-to-digital converter (TDC) that may be included in the photosensitive element or separately from the photosensitive element. The TDC may receive the photon event, determine a timestamp that is a digital representation of a time of detecting the photon, generate a timestamped photon event that indicates the detected single photon and its timestamp of detection, and output the timestamped photon event.

Performing time-correlated photon counting may allow to measure a round-trip time of photons that correspond to the signal, i.e., to a reflection of the light signal emitted by the light emission unit. Based on the round-trip time, a distance to an object in the scene that has reflected the light signal may be determined.

In some embodiments, the imaging sensor further includes a histogram unit configured to generate, based on the timestamps of detection of the single photons, a histogram that indicates a count of detected single photons in each of a plurality of time intervals; and a peak detection unit configured to detect, in the histogram, a peak that indicates the detected signal.

The histogram unit may include any circuitry capable of generating a histogram. The peak detection unit may include any circuitry capable of detecting a peak in a histogram. For example, the histogram unit and/or the peak detection unit may include an application-specific integrated circuit (ASIC) and/or a field-programmable gate array (FPGA). The peak detection unit may be included in the histogram unit or may be provided separately from the histogram unit.,

The histogram may include a plurality of histogram bins. Each histogram bin may be associated with a respective time interval of the plurality of time intervals. The plurality of time intervals may be related with a timing of the light signal emitted by the light emission unit; for example, each time interval of the plurality of time intervals may correspond to a time that has elapsed since a last laser pulse emitted by the light emission unit.

The histogram unit may receive timestamped photon events from the photosensitive element (and, in some embodiments, from photosensitive elements of further pixels of the imaging sensor), or from one or more respective TDCs, and assign each timestamped photon event to a histogram bin that is associated with a time interval that includes a point of time indicated by the timestamp of the timestamped photon event.

The histogram unit may include a histogram memory for storing the histogram. For example, when the histogram unit receives a timestamped photon event, the histogram unit may update the histogram (e.g., assign the received timestamped photon event to a corresponding histogram bin) and store the updated histogram in the histogram memory.

The peak in the histogram may include one or more (e.g., adjacent) histogram bins of the plurality of histogram bins that have more timestamped photon events assigned than the other bins of the plurality of histogram bins. The peak detection unit may analyze the histogram for detecting a peak in the histogram.

For example, the peak detection unit may analyze the histogram for detecting a peak in the histogram for each detected timestamped photon event. Alternatively, for reducing an energy consumption, the peak detection unit may analyze the histogram for detecting a peak in the histogram after every predetermined or configurable number of timestamped photon events, after every predetermined or configurable number of laser cycles (e.g., after every predetermined or configurable number of emitted laser pulses) or at a predetermined or configurable rate (e.g., each time a predetermined or configurable time period elapses).

For example, a number of histogram bins included in the peak may correspond to a duration of a laser pulse. For example, the peak detection unit may detect the peak based on the maximum bin count (e.g., on a highest photon count among the plurality of histogram bins). For example, the peak detection may detect the peak based on a mean, a sum or the like of bin counts of all histogram bins included in the peak. For example, the peak detection unit may detect the peak based on a predetermined threshold.

For example, the peak detection unit may detect the peak based on a programmable filter. The programmable filter may amplify and/or attenuate a photon count of at least one of the plurality of histogram bins such that the peak detection unit can detect the peak in the histogram earlier and/or more robustly. For example, the programmable filter may attenuate or remove noise in the histogram based on a low-pass filter and/or on a predetermined probability distribution that models noise. For example, peak detection unit may perform edge enhancement, e.g. based on unsharp masking, on the histogram for emphasizing the peak. For example, the peak detection unit may convolve the plurality of histogram bins (and their respective photon counts) with an impulse response function of an emitted laser pulse. In some embodiments where photon counts in the plurality of histogram bins (e.g., in histogram bins that correspond to the peak) resemble the impulse response function of the emitted laser pulse, an output of such a convolution may provide a larger SNR or SBR than directly applying a threshold to the photon counts of the plurality of histogram bins. However, the description is not limited to these filters. The peak detection unit may apply any suitable filter to the histogram for detecting the peak.

For example, when the peak detection unit detects a peak in the histogram, the peak detection unit may raise an interrupt that may be propagated to the photosensitive element and/or to the light emission unit. The photosensitive element may stop integrating incident light when it receives the interrupt, and the light emission unit may stop emitting the light signal when it receives the interrupt.

In some embodiments, the detecting of the peak includes determining that the count of detected single photons in a time interval of the plurality of time intervals exceeds a predetermined threshold.

For example, the peak detection unit may detect the peak if a number of timestamped photon events assigned to a histogram bin that corresponds to the time interval exceeds the predetermined threshold.

For example, the predetermined threshold may be fixed or may be determined by the peak detection unit based on the histogram according to a predetermined rule.

In some embodiments, the predetermined threshold is based on a background level.

For example, the predetermined threshold may represent a predetermined amount, percentage or level above the background level.

For example, the predetermined threshold may be based on a SBR or on a SNR, wherein the background level is represented by the background/noise of the SBR/SNR. For example, the SBR may correspond to a quotient of a highest photon count assigned to a histogram bin of the plurality of histogram bins and the background level. For example, the SNR may correspond to a quotient of the highest photon count assigned to a histogram bin of the plurality of histogram bins and a square root of the background level.

For example, the background level may be based on an average photon count, a maximum photon count or a predetermined percentile of a photon count of histogram bins.

For example, the background level may be based on clustering, e.g., on k-means clustering, hierarchical clustering and/or density-based spatial clustering of applications with noise (DBSCAN) of a photon count of histogram bins.

In some embodiments, the peak detection unit is configured to determine the background level based on low-pass filtering of counts of detected single photons in the plurality of time intervals.

For example, the low-pass filtering may include applying a moving average, a moving median, a Gaussian smoothing and/or reducing a high-frequency component of a Fourier transform.

The low-pass filtering may allow reducing an influence of outlier bins (e.g., of histogram bins that correspond to a peak) on a determination of the background level and, thus, may make a determination of the background level more robust.

In some embodiments, the peak detection unit is configured to determine the background level based on counts of detected single photons in a cluster of time intervals, of the plurality of time intervals, that correspond to the background signal.

For example, histogram bins (time intervals) that correspond to the background signal may be determined based on the low-pass filtering, e.g., histogram bins whose photon count deviates less than a predetermined threshold from a series of photon counts that has been obtained by the low-pass filtering of the histogram. For example, outlier bins of the histogram and/or bins that correspond to a peak in the histogram may be excluded from the determination of the background level.

In some embodiments, the peak detection unit is further configured to analyze the histogram for detecting the peak and determine the background level during a same loop through the plurality of time intervals.

For example, the peak detection unit may store an indicator of a histogram bin (time interval) with a highest photon count and its photon count and may iteratively update the indicator during iterating through the histogram bins (time intervals) for determining the background level.

Thus, it may be possible to avoid two separate loops over the histogram bins (time intervals) for determining the background level and for detecting the peak, such that the peak detection may be faster than if the peak detection unit performed two separate loops for peak detection and background level determination.

In some embodiments, the peak detection unit is configured to analyze the histogram for detecting the peak when the photosensitive element detects a single photon that corresponds to a time interval with a highest count of detected single photons among the plurality of time intervals.

This feature may be based on the assumption that a peak in the histogram includes a histogram bin (time interval) with a highest photon count and that a peak is detected once the histogram bin with the highest photon count fulfills a peak criterion (e.g., the highest photon count exceeds a predetermined threshold). Thus, it may be assumed that a newly detected single photon that does not correspond to a histogram bin with a highest photon count does not cause a peak in the histogram to be detected.

Therefore, unnecessary consumption of electrical energy and/or of processing resources may be avoided by analyzing the histogram for detecting the peak only when single photons are detected that correspond to a histogram bin (time interval) with a highest photon count.

In some embodiments, the histogram unit further includes a maximum register that indicates the time interval with the highest count of detected single photons and the corresponding count of detected single photons.

For example, the maximum register may store an indicator of the histogram bin (time interval) with the highest photon count (e.g., a memory address of the histogram bin or a time value that corresponds to a lower and/or upper edge of the histogram bin) and an indicator of the corresponding photon count (e.g., a memory address of the photon count or an integer or floating point value that corresponds to the photon count). The maximum register may indicate the corresponding count of detected single photons by indicating the corresponding histogram bin (time interval) such that the histogram unit can retrieve the corresponding count of detected single photons from the respective histogram bin. Alternatively, the maximum register may store only a value that corresponds to the highest photon count, and the maximum register may indicate the histogram bin with the highest photon count indirectly by indicating the highest photon count.

Thus, when the histogram unit receives a new timestamped photon event, the histogram unit may update the histogram and compare the timestamp of the photon event with the histogram bin indicated by the maximum register.

If the new timestamped photon event corresponds to the histogram bin indicated by the maximum register, or if the updated photon count of the histogram bin to which the new timestamped photon event has been assigned exceeds the photon count indicated by the maximum register, the histogram unit may update the maximum register accordingly and may cause the peak detection unit to analyze the histogram for detecting a peak.

The histogram unit may determine whether the new timestamped photon event corresponds to a histogram bin with a highest photon count, the histogram unit may, in some embodiments, only compare, after assigning the new timestamped photon event to a histogram bin, the photon count of the histogram bin to which the new timestamped photon event has been assigned to the highest photon count indicated by the maximum register. In such an embodiment, the maximum register need only store a value that indicates the highest photon count (and, thus, indicates indirectly a histogram bin with the highest photon count), and a size of the maximum bin can be kept smaller.

However, in some embodiments where the maximum register directly indicates the histogram bin with the highest photon count, the histogram unit can determine that the new timestamped photon event corresponds to the histogram bin with the highest photon count before the histogram unit has updated the histogram, and the peak detection unit can earlier start analyzing the histogram for detecting a peak and/or for determining a background level of the histogram. In such a case, a peak detection may be faster, for example, if the peak detection unit can start analyzing the histogram in parallel while the histogram unit may still be updating the histogram, wherein, e.g., an access of the peak detection unit to the histogram bin with the highest photon count (to which the new timestamped photon is assigned) may be restricted based on a lock or semaphore for avoiding a race condition. If an access of the peak detection unit to the histogram bin with the highest photon count fails due to the lock or semaphore, the peak detection unit may, e.g., wait for the lock or semaphore to be released, may proceed iterating through the remaining histogram bins and then retry to access the locked histogram bin, or may determine the highest photon count based on incrementing a previous highest photon count (e.g., obtained from the maximum register).

Otherwise, if the new timestamped photon event does not correspond to the histogram bin indicated by the maximum register and does not cause a photon count of a histogram bin to exceed the photon count indicated by the maximum register, the histogram unit may, for saving electrical energy and/or processing resources, not cause the peak detection unit to analyze the histogram for detecting a peak.

In some embodiments, the peak detection unit is further configured to detect, in the histogram, a peak candidate that is lower than the detected peak and cause the photosensitive element to continue the integration after detecting the peak.

The peak candidate may include a histogram bin (time interval) whose photon count exceeds the noise level by a predetermined amount, percentage or level (e.g., exceeds a predetermined candidate threshold that is lower than the predetermined threshold for detecting a peak) but is not detected as a peak (e.g., does not exceed the predetermined threshold for detecting a peak).

A presence of one or more candidate peaks in addition to the detected peak may indicate that the photosensitive element receives a plurality of reflections of the light signal. The plurality of reflections may, for example, be caused by reflections of the light signal between two or more objects in the scene or by a transparent object (e.g., a glass pane) arranged in front of another object in the scene. Depending on a specific application, a correction of the reflections between the two or more objects or a selection between the transparent object and the object behind it may be required.

Thus, if the peak detection unit detects a peak candidate in the histogram, the peak detection unit may not raise an interrupt for causing the photosensitive element to stop the integration of incident light, such that the photosensitive element may continue integrating incident light until the peak detection unit can, based on an evolution of the peak candidate relative to the background level, confirm or negate that the peak candidate corresponds to another peak in the histogram.

In some embodiments, the imaging sensor further includes a further photosensitive element that is configured to integrate incident light and continue the integration of incident light when the photosensitive element stops the integration of incident light if no signal is detected in the incident light integrated by the further photosensitive element.

For example, the imaging sensor may include a plurality of pixels, which may be arranged in a pixel array, and each pixel of the pixel array may include a photosensitive element that is configured to integrate incident light. A photosensitive element of each pixel of the pixel array may stop integrating incident light when a peak is detected in a histogram that is based on single photons detected by the respective photosensitive element. A photosensitive element of each pixel of the pixel array may continue integrating incident light as long as a peak is not (yet) detected in a histogram that is based on single photons detected by the respective photosensitive elements, irrespective of whether photosensitive elements of other pixels have stopped an integration of incident light. Photosensitive elements of pixels for which a peak is not detected may stop integrating incident light when a global exposure expires.

Thus, a photosensitive element of each pixel may integrate incident light as long as necessary for detecting a peak in its corresponding histogram, and may stop integrating incident light upon detection of a peak in its corresponding histogram for saving electrical energy.

Some embodiments pertain to an imaging method for imaging with the imaging sensor described above, wherein the imaging method includes integrating incident light; and stopping the integration of incident light when a signal is detected in the integrated incident light.

The imaging method may be performed by an imaging sensor of any configuration described above as an embodiment. Therefore, the imaging method according to an embodiment may have any feature (or combination of features) that correspond(s) to a feature (or combination of features) of an imaging sensor described above as an embodiment.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 2, FIG. 2 shows a block diagram of an imaging sensor 10 according to an embodiment. The imaging sensor 10 includes a pixel array 11, a time-to-digital converter (TDC) bank 12, a histogram block unit 13 and an emitter VCSEL array integrated circuit (IC) 14.

The pixel array 11 includes a plurality of pixels. Each pixel of the pixel array 11 is an example of a photosensitive element and is configured to integrate incident light. The photosensitive element of each pixel in the pixel array includes a single-photon avalanche diode (SPAD), and the integrating of incident light includes detecting, with the SPAD, single photons of the incident light.

The imaging sensor 10 includes a lens (not shown in FIG. 2) provided in front of the pixel array 11 such that each pixel of the pixel array 10 receives light from a portion of a scene that depends on a focal length and a distance of the lens. Thus, each pixel of the pixel array 11 corresponds to a respective portion of the scene.

The emitter VCSEL array IC 14 includes a VCSEL array 14a. Each VCSEL of the VCSEL array 14a is an example of a light emission unit and is configured to emit a laser dot in a predetermined direction into a scene. The laser dot is an example of a light signal. The VCSELs of the VCSEL array 14a emit the laser dot repeatedly as laser pulses.

If the laser dot emitted by a VCSEL of the VCSEL array 14a into the scene is reflected to the pixel array 11 by an object in the scene, photons of the reflected laser dot are received, as part of incident light, by a pixel of the pixel array 11 that corresponds to a portion of the scene where the object is located and from where the laser dot is reflected.

As an example, the VCSEL 14b of the VCSEL array 14a emits a laser dot in a direction of a portion of the scene to which the pixel 11a of the pixel array 11 corresponds. Thus, a reflection of the laser dot emitted by the VCSEL 14b is received by the pixel 11a.

In addition to photons from a reflected laser dot, the incident light further includes photons of a background signal. The background signal includes ambient light. It is assumed that a background level, i.e., a level of the background signal, does not change during a distance measurement performed by the imaging sensor 10.

When a pixel of the pixel array 11 detects a photon of the incident light, it outputs a photon detection signal indicating a photon event (i.e., a detection of a photon) to a TDC in the TDC bank 12. The TDC times the photon event, i.e., it generates a timestamped photon event that corresponds to the detected photon, and outputs the timestamped photon event to a histogram block of the histogram block unit 13 that corresponds to the pixel that has detected the photon. As an example, the TDC outputs a timestamped photon event that corresponds to a photon detected by the pixel 11a to the histogram block 15 of the histogram block unit 13.

The histogram blocks of the histogram block unit 13 are examples of histogram units. The histogram blocks are described in detail using the example of the histogram block 15. The histogram block 15 includes a histogram update unit 15a, a histogram memory 15b, a maximum register 15c and a peak detection unit 15d.

The histogram update unit 15a receives timestamped photon events 16 output by a TDC of the TDC bank 12 to the histogram block 15 and updates a histogram 15 that is associated with the pixel 11a according to the respective timestamped photon events 16.

The histogram memory 15b stores the histogram 15e that is associated with the pixel 11a. The histogram 15e includes a plurality of histogram bins, each of which is associated with a respective time interval of a predetermined plurality of time intervals that indicate a time elapsed between a point in time at which the VCSEL 14b has emitted a laser pulse and the detection of the photon by the pixel 11a. The histogram 15e further includes, for each histogram bin of the plurality of histogram bins, a number of timestamped photon events (photon count) whose timestamp corresponds to the time interval of the plurality of time intervals associated with the histogram bin.

For updating the histogram 15e, the histogram update unit 15a determines a histogram bin (time interval), of the plurality of histogram bins of the histogram 15e, to which the timestamped photon event 16 corresponds, and increments (i.e., increases by one) the photon count of the corresponding histogram bin. The histogram update unit 15a then writes the updated photon count of the corresponding histogram bin into the histogram memory 15b.

The pixel 11a detects photons that correspond to a background signal (e.g., to ambient light) at times that are uncorrelated to emission times of laser pulses emitted by the VCSEL 14b, whereas the pixel 11a detects photons that correspond to a reflection of a laser pulse emitted by the VCSEL 14b at times that correspond to a roundtrip time of the laser pulse and, thus, to a distance between the imaging sensor 10 and an object in the scene that reflects the laser pulse. Therefore, histogram bins of the histogram 15e that correspond to the roundtrip time of the laser pulse have a higher photon count than histogram bins of the histogram 15e that do not correspond to the roundtrip time of the laser pulse.

However, points in time at which the pixel 11a detects a single photon are stochastically distributed for both the reflected laser pulse and the background signal. Therefore, the pixel 11a integrates incident light until a signal that corresponds to the reflected laser pulse can be detected as a peak in the histogram 15e. In the embodiment of FIG. 2, the exposure (integration time) required until a peak is detected in the histogram 15e is longer than a roundtrip time of the laser pulse from the imaging sensor 10 to an object in the scene and back to the imaging sensor 10. Thus, the VCSEL 14b emits the laser pulse (i.e., emits the laser dot) repeatedly and the pixel 11a repeatedly integrates incident light after each laser pulse.

The histogram update unit 15a updates the histogram 15e for each timestamped photon event 16 it receives, wherein it assigns the timestamped photon event 16 to a histogram bin (time interval) that corresponds to a time elapsed since the respective last laser pulse emitted by the VCSEL 14b before the pixel 11a detects the photon. Thus, the histogram update unit 15a integrates the histogram over repetitions of the laser dot emitted by the VCSEL 14b.

While the pixel 11a is integrating incident light and the histogram update unit 15a is updating the histogram 15e for each received timestamped photon event 16, the peak detection unit 15d repeatedly analyzes the histogram 15e for detecting a peak that indicates a signal in the incident light that corresponds to a reflection from an object in the scene of the laser pulse emitted by the VCSEL 14b. I.e., the peak detection unit 15d checks the histogram 15e to find the peak.

To reduce an amount of electrical energy consumption, the peak detection unit 15d analyzes the histogram 15e for detecting a peak only when the histogram 15e is updated with a timestamped photon event 16 that corresponds to a histogram bin with a highest photon count among the plurality of histogram bins.

For this purpose, the histogram update unit 15a compares each timestamped photon event 16 with the maximum register 15c of the histogram unit 15. The maximum register 15c indicates a histogram bin (time interval) that has a highest photon count among the plurality of histogram bins, and indicates the corresponding highest photon count. Thus, for determining whether a timestamped photon event 16 corresponds to a histogram bin with a highest photon count, the histogram update unit 15a need not iterate through the histogram 15e, but compares whether the timestamp of the timestamped photon event 16 corresponds to the histogram bin with a highest photon count indicated by the maximum register 15c or, if not, whether a photon count of a histogram bin to which the timestamped photon event 16 has been assigned exceeds the highest photon count indicated by the maximum register 15c. If one of these two conditions is fulfilled, the histogram update unit 15a updates the maximum register 15c accordingly and causes the peak detection unit 15d to analyze the histogram 15e for detecting a peak. Else, the histogram update unit 15a does not cause the peak detection unit 15d to analyze the histogram 15e for detecting a peak.

Thus, it is possible that the peak detection unit 15d analyzes the histogram 15e for detecting a peak in the histogram 15e when the timestamped photon event 16 and, thus, the single photon detected by the pixel 11a, corresponds to a histogram bin (time interval) with a highest count of detected single photons among the plurality of histogram bins (time intervals), and does not analyze the histogram 15e if the timestamped photon event 16 corresponds to a histogram bin with a lower photon count.

When the histogram update unit 15a causes the peak detection unit 15d to analyze the histogram 15e for detecting a peak, the peak detection unit 15d reads the (updated) histogram 15e from the histogram memory 15b, obtains a background level of the histogram 15e and determines a threshold based on the background level for detecting a peak.

For determining the background level of the histogram 15e, the peak detection unit 15d determines, based on a percentile of the photon counts of the histogram bins of the histogram 15e, a cluster of histogram bins (time intervals) that correspond to a background signal, and applies a low-pass filter to the photon counts of the histogram bins that correspond to the background signal.

The peak detection unit 15d then determines the threshold based on a predetermined algorithm from the background level of the histogram 15e.

After determining the threshold, the peak detection unit 15d compares the photon count of the histogram bin with a highest photon count in the histogram 15e to the threshold and detects a peak in the histogram 15e if the photon count in the histogram bin (time interval) with the highest photon count exceeds the threshold.

A peak detected by the peak detection unit 15d in the histogram 15e represents to a signal in the incident light received by the pixel 11a that corresponds to a reflection of the laser pulse emitted by the VCSEL 14b from the scene. Therefore, detecting a peak in the histogram 15e, which is based on timestamps of detection of single photons detected by the pixel 11a, corresponds to detecting the signal in the incident light integrated by the pixel 11a.

For both determining the background level and analyzing the histogram for detecting a peak, the peak detection unit 15d loops through the plurality of histogram bins (time intervals). To avoid looping twice through the histogram 15e, the peak detection unit 15e analyzes the histogram for detecting a peak and determines the background level of the histogram 15e during a same loop through the plurality of histogram bins.

If the peak detection unit 15d detects a peak in the histogram 15e, the peak detection unit 15e raises a pixel/dot interrupt 17 for stopping the pixel 11a integrating incident light and for stopping the VCSEL 14b emitting the laser pulse (laser dot). When the peak detection unit 15e raises the pixel/dot interrupt 17, an autoexposure interrupt handshake 18 is performed for forwarding the pixel/dot interrupt 17 to the pixel 11a and to the VCSEL 14b that correspond to the histogram 15e in which the peak has been detected.

The autoexposure interrupt handshaking 17 causes the pixel 11a to receive the pixel/dot interrupt 17. When the pixel 11a receives the pixel/dot interrupt 17, the pixel 11a stops the integration of incident light (i.e., stops detecting single photons of the incident light) because a signal is detected in the incident light integrated by the pixel 11a and further integration is not necessary for determining a distance to an object from which the pixel 11a receives the reflected laser pulse.

The autoexposure interrupt handshaking 17 further causes a VCSEL driver and addressing unit 14c that is included in the emitter VCSEL array IC 14 to receive the pixel/dot interrupt 17. Since a reflection of the laser dot emitted by the VCSEL 14b can be received by several pixels of the pixel array 11, depending on a distance of an object in the scene that reflects the laser dot, the VCSEL driver and addressing unit 14c determines, upon receiving the pixel/dot interrupt 17, whether a pixel/dot interrupt 17 has been raised for all pixels of the pixel array 11 that receive a reflection of the laser dot emitted by the VCSEL 14b.

If a pixel/dot interrupt 17 has been raised for all pixels of the pixel array 11 that receive a reflection of the laser dot emitted by the VCSEL 14b, i.e., if a peak/signal is detected for all pixels that receive the reflection of the laser dot emitted by the VCSEL 14b, the VCSEL driver and addressing unit 14c controls the VCSEL 14b to stop emitting the laser dot (laser pulses) into the scene for saving electrical energy.

The peak detection unit 15d further performs a candidate detection. The peak detection unit 15e detects, as a peak candidate, a histogram bin of the histogram 15e that is not associated with a detected peak and whose photon count is higher than the background level but lower than the threshold for detecting a peak. If the peak detection unit 15d detects a peak in the histogram 15e while the histogram 15e also includes a peak candidate, the peak detection unit 15d delays raising the pixel/dot interrupt 17, thus causing the pixel 11a to continue the integration of incident light after detecting the peak. The delaying includes not raising the pixel/dot interrupt 17 for a predetermined delay time (a predetermined number of laser pulses of the VCSEL 14b, in the embodiment of FIG. 2). After the predetermined delay time, the peak detection unit 15d determines whether the peak candidate can be determined to be an additional peak in the histogram 15e that corresponds to a reflection of the laser dot from the scene or must be determined to be a part of the background signal. After the predetermined delay time has elapsed, the peak detection unit 15d raises the pixel/dot interrupt 17 for causing the pixel 11a to stop the integration of incident light.

When the pixel 11a receives the pixel/dot interrupt 17 and stops integrating incident light, a further pixel (that is an example of a further photosensitive element) of the pixel array 11 that has been integrating incident light when the pixel 11a received the pixel/dot interrupt 17 continues the integration of incident light if (and as long as) no signal is detected in the incident light integrated by the further pixel.

Thus, the pixel 11a stops the integration of incident light independent of whether further pixels of the pixel array 11 stop or continue integrating incident light. A determination whether to cause any pixel of the pixel array 11 to stop integrating incident light is based on whether a peak (and, possibly, a peak candidate) is detected in a histogram of timestamped photon events of the respective pixel, regardless of other pixels of the pixel array.

Accordingly, when a peak that corresponds to a reflection of a laser dot emitted by the VCSEL 14b is detected on top of the background level in the histogram 15e, the peak detection unit 15d raises a pixel/dot interrupt 17 which is propagated to the pixel 11a and VCSEL 14b that correspond to the histogram 15e in which the peak is found. The pixel 11a and VCSEL 14b, which correspond to the histogram 15e in which the peak is found, are disabled by the arrival of the pixel/dot interrupt 17. The rest of the pixels of the pixel array 11 and of the VCSELs of the VCSEL array 14a that are still enabled continue integrating incident light until disabled by their corresponding peak detection unit or until the integration time (exposure) finishes at an end of a frame capture.

It is noted that, although the TDC bank 12 is illustrated separately from the pixel array 11 in FIG. 2 for illustrational purposes, a TDC that generates a timestamped photon event is included in each pixel of the pixel array 11 in some embodiments.

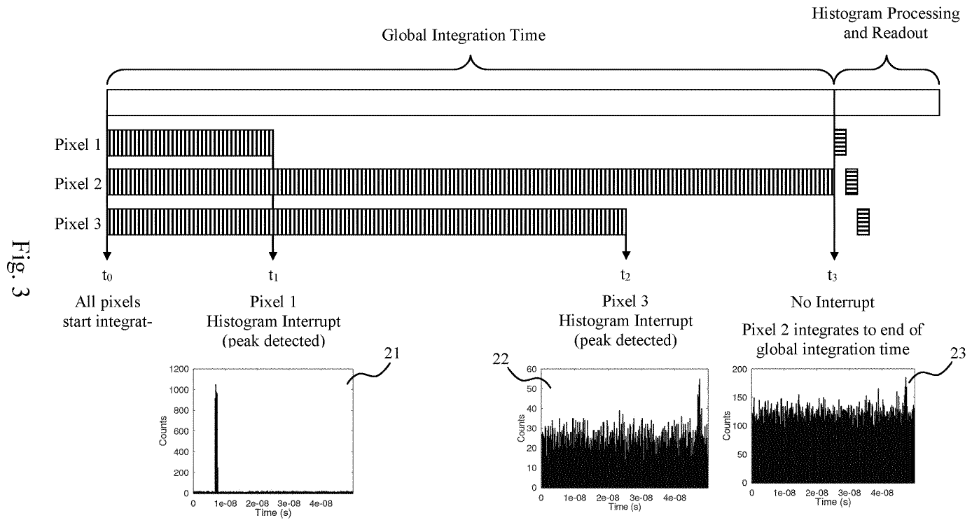

FIG. 3 illustrates a pixel duty cycle according to an embodiment. FIG. 3 shows an exposure for three pixels (“Pixel 1”, “Pixel 2” and “Pixel 3” in FIG. 3) in a global integration time of one duty cycle of the imaging sensor 10 of FIG. 2. The duty cycle corresponds to one distance measurement performed by the imaging sensor 10, i.e., to one depth map generated by the imaging sensor 10. Each of the three pixels in FIG. 3 is an example of a photosensitive element according to the present disclosure and is configured similar to the pixel 11a of FIG. 2.

At t₀, a global integration time starts. The VCSEL array 14a starts repeatedly emitting laser pulses (laser dots) into the scene, and the pixels of the pixel array 11 (including the “Pixel 1”, “Pixel 2” and “Pixel 3” of FIG. 3) start integrating incident light, i.e., detecting single photons. Periods in which the respective pixels are integrating incident light are illustrated as vertically hatched bars in FIG. 3.

At t₁, a peak detection unit of a corresponding histogram block of the histogram block unit 13 detects a peak early in relation to the global integration time in a histogram 21 that corresponds to “Pixel 1”, and the peak detection unit raises an interrupt such that “Pixel 1” stops integration of incident light.

At t₂, a peak detection unit of a corresponding histogram block of the histogram block unit 13 detects a peak in a histogram 22 that corresponds to “Pixel 3” and raises an interrupt such that “Pixel 3” also stops integration before the global integration time ends. The peak in the histogram 22 that corresponds to “Pixel 3” is detected later than for “Pixel 1” due to a worse (lower) SBR of the histogram 22 that corresponds to “Pixel 3” than for the histogram 21 that corresponds to “Pixel 1”.

A SBR of a histogram 23 that corresponds to “Pixel 2” is so low that a peak detection unit of a corresponding histogram block of the histogram block unit 13 does not detect a peak in the histogram 23 and, therefore, does not raise an interrupt. Accordingly, “Pixel 2” and a corresponding VCSEL of the VCSEL array 14a that emits a laser dot whose reflections are received by “Pixel 2” continue operating until the global integration time ends at t₃.

Corresponding VCSELS of the VCSEL array 14a, that emit laser dots whose reflections are received by the respective pixels, are also disabled from further emitting the laser dots when the respective corresponding pixel stops integrating incident light.

At t₃, as mentioned, the global integration time ends and all pixels of the pixel array 11 for which no signal (peak in a corresponding histogram) has been detected yet stop integrating incident light at t₃. Likewise, all VCSELS of the VCSEL array 14a that have still been emitting laser pulses stop emitting laser pulses at t₃.

After the global integration time has ended, a histogram processing and readout is performed. During the histogram processing and readout, a measured distance is determined for each histogram (including the histograms 21, 22 and 23) generated during the global integration time. Periods of determining a measured distance for the respective histograms 21, 22 and 23 are illustrated in FIG. 3 as horizontally hatched bars.

During the histogram processing and readout, a more elaborate algorithm is performed for determining a measured distance from the histograms than an algorithm used by the peak detection units for detecting a peak during the global integration time. Thus, during the histogram processing and readout, a measured distance can be determined also for some histograms in which no peak has been detected by a corresponding peak detection unit during the global integration time.

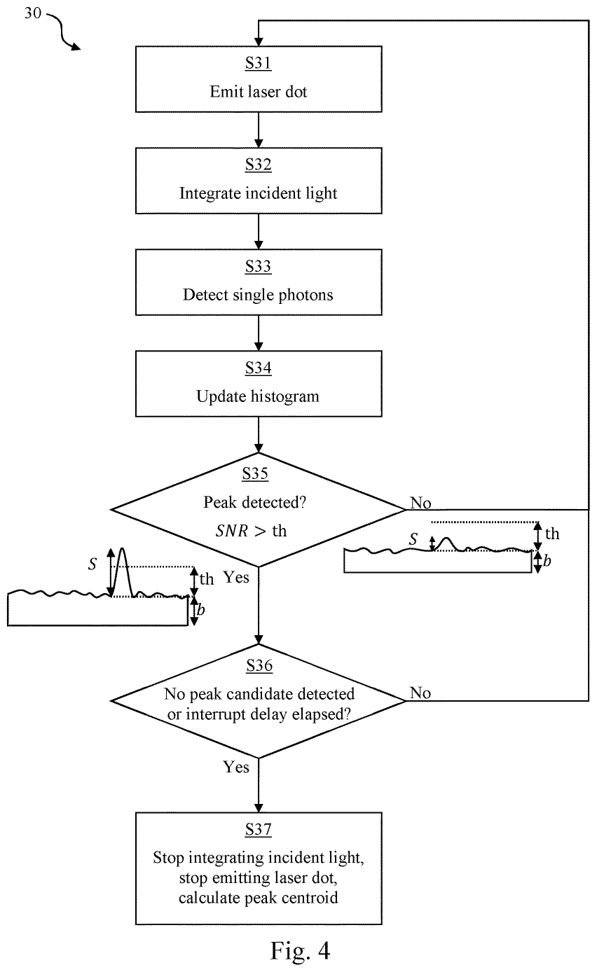

FIG. 4 illustrates a flow diagram of an imaging method 30 according to an embodiment. The imaging method 30 is performed by the imaging sensor 10 of FIG. 2.

At S31, the VCSEL 14b of the VCSEL array 14a emits a laser dot (laser pulse) into a scene. The VCSEL 14b is an example of a light emission unit according to the present disclosure, and the laser dot is an example of a light signal according the present disclosure. The laser dot is reflected by an object in the scene to the pixel array 11.

At S32, the pixel 11a of the pixel array 11 starts integrating incident light. As mentioned, the pixel 11a is an example of a photosensitive element according to the present disclosure.

At S33, the pixel 11a detects single photons of the incident light. The single photons detected by the pixel 11a include photons from a background signal (including ambient light) and photons from the reflection of the laser dot emitted by the VCSEL 14b. For each photon detected by the pixel 11a, a corresponding TDC of the TDC bank 12 generates a timestamped photon event 16 that indicates the detected photon and its time of detection (relative to the last laser pulse emitted by the VCSEL 14b). The TDC then provides the timestamped photon events 16 for the detected photons to the histogram block 15.

At S34, the histogram update unit 15a generates the histogram 15e, which indicates a count of single photons detected by the pixel 11a in each of a plurality of time intervals, based on the timestamped photon events 16. The generating of the histogram 15e includes updating the histogram 15e for each timestamped photon event and storing the updated histogram 15e in the histogram memory 15b. The histogram update unit 15a determines, based on the maximum register 15c, for each timestamped photon event 16 whether the timestamped photon event 16 corresponds to a histogram bin with a highest photon count among the plurality of histogram bins. If a timestamped photon event 16 corresponds to the histogram bin with the highest photon count, the histogram update unit 15a updates the maximum register 15c accordingly and causes the peak detection unit 15d to analyze the histogram 15e for detecting a peak.

At S35, the peak detection unit 15d analyzes the histogram 15e for detecting in the histogram 15e a peak that indicates a signal that corresponds to the reflected laser pulse. The peak detection unit 15d determines a cluster of histogram bins (time intervals) of the histogram 15e that correspond to the background signal, performs a low-pass filtering of photon counts of the histogram bins in the cluster, determines a background level b of the histogram 15e based on the low-pass filtered photon counts and calculates, based on the background level b, a threshold th for detecting a peak according to a predetermined algorithm.

For detecting a peak in the histogram 15e, the peak detection unit 15d then determines whether the photon count of the histogram bin of the histogram 15e with the highest photon count exceeds the threshold th, i.e., whether an amount S that indicates a height of the highest photon count above the background level b exceeds the threshold th, such that a signal-to-noise ratio SNR of the highest photon count S exceeds a corresponding threshold th. The peak detection unit 15d analyzes the histogram 15e for detecting the peak and determines the background level b during a same loop through the plurality of histogram bins (time intervals) of the histogram 15e.

If the highest photon count S (and, accordingly, the corresponding SNR) exceeds the threshold th, the peak detection unit 15d detects a peak according to the histogram bin with the highest photon count. The detected peak is, thus, detected based on timestamps of detection of the single photons detected by the pixel 11a from a reflection of the laser pulse emitted by the VCSEL 14b and indicates a roundtrip time of the laser pulse.

If the peak detection unit 15d does not detect a peak in the histogram 15e at S35, the imaging method 30 continues at S31 unless a global integration time has ended.

If the peak detection unit 15d detects a peak in the histogram 15e at S35, the peak detection unit 15d determines, at S36, whether a peak candidate can be detected in the histogram 15e. A peak candidate is indicated by a histogram bin with a photon count that does not exceed the threshold th but exceeds the background level b and might also become a peak (i.e., exceed the threshold th) if the integration of incident light and the updating of the histogram 15e is continued.

Therefore, if the peak detection unit 15d detects a candidate peak, the peak detection unit 15d does not raise an interrupt 17 for causing the pixel 11a to stop the integration of incident light within a predetermined interrupt delay. Thus, the peak detection unit 15d causes the pixel 11a to continue the integration of incident light after the peak detection unit 15d has detected the peak.

When the interrupt delay elapses, the peak detection unit 15d raises an interrupt 17 for causing the pixel 11a to stop the integration of incident light and determines whether the candidate peak has evolved, during the candidate delay, to an additional peak in the histogram 15e. Likewise, if the peak detection unit 15d does not detect a peak candidate in the histogram 15e at all, the peak detection unit 15d raises an interrupt 17 for causing the pixel 11a to stop the integration of incident light. Else, if the peak detection unit 15d has detected a peak candidate in the histogram 15e and the corresponding interrupt delay has not elapsed yet, the peak detection unit 15d does not raise an interrupt 17 for causing the pixel 11a to stop the integration of incident light, and the imaging method 30 continues at S31 unless the global integration time has ended.

If the peak detection unit 15d raises an interrupt 17 for causing the pixel 11a to stop the integration of incident light, the imaging method 30 proceeds to S37.

At S37, the interrupt 17 raised by the peak detection unit 15d is propagated to the pixel 11a. When the pixel 11a receives the interrupt 17, the pixel 11a stops the integration of incident light. Also, at S37, the interrupt 17 is propagated to the VCSEL 14b, which has emitted the laser pulse, if a corresponding interrupt 17 has been raised for causing all pixels of the pixel array 11 that receive a reflection of the laser pulse emitted by the VCSEL 14b to stop an integration of incident light. When the VCSEL 14b receives the interrupt 17, the VCSEL 14b stops emitting the laser pulse (laser dot) into the scene.

Further, at S37, a centroid of the peak detected in the histogram 15e is calculated for determining a measured distance that corresponds to the pixel 11a.

The imaging method 30 performs S35 to S37 separately for each pixel of the pixel array 11. I.e., when the pixel 11a stops the integration of incident light because a peak is detected in the histogram 15e that corresponds to the pixel 11a, and, thus, because a signal is detected in the incident light integrated by the pixel 11a, before the global integration time ends, a further pixel of the pixel array 11 continues an integration of incident light if no signal is detected in the incident light integrated by the further pixel (i.e., if no peak is detected in a histogram that corresponds to the further pixel).

While, in some embodiments, the threshold for detecting a peak by the peak detection unit 15d of FIG. 2 and/or by the peak detection at S35 of FIG. 4 is fixed, some embodiments set the threshold adaptively based on the respective histogram, e.g., based on a background level of the histogram.

In some embodiments, the peak needs to be identified on top of the background level. However, photons may be affected by shot noise, which may cause a localization of false peaks especially at low photon counts.

According to an embodiment with adaptive peak threshold setting, a standard deviation of the shot noise is \sqrt{b}, where b represents the mean background count.

For detecting a peak, the peak detection unit 15d and/or the peak detection at S35 determines whether peak counts (i.e., photon counts of one or more histogram bins that correspond to a peak) exceed a threshold th. The threshold th is based on the following equation, which is based on a shot noise limited bit error rate in optical comms:

$$\\ th = 2 Q \sqrt{b} + {Q}^{2} + b , where Q = \sqrt{2} {erfc}^{- 1} ( 2 - 2 P ) .$$

Therefore, the peak detection unit 15d and/or the peak detection at S35 takes histogram bins that correspond to a background signal to compute b and therefore th. Q is a configurable constant dependent on a probability P of peak detection.

Therefore, each histogram block 15 of the histogram block unit 13 configures its own threshold th for detecting a peak dependent on the respective background rate.

Counts that correspond to a signal S can be computed in different ways, for example, by taking an average of photon counts in a signal peak (minus background) or just taking the peak bin counts (minus background).

The threshold th as described above corresponds to the threshold th of the peak detection at S35 in FIG. 4 in some embodiments. However, the way the threshold th is set is not limited to the above parameters or algorithm but may depend on other parameters or on another algorithm in some embodiments.

Hereinafter, options for configurations of an imaging sensor and an imaging method according to the disclosure are described.

For example, some options for determining a frequency of a histogram check (i.e., of analyzing a histogram for detecting a peak) are provided below. It is noted, however, that the disclosure is not limited to these options.

In some embodiments, according to a brute force approach, the histogram check is performed on every new detected photon (e.g., timestamped photon event). This approach may, however, risk a high electrical power consumption.

In some embodiments, the histogram check is performed every predetermined number of detected photons. For example, the histogram check may be performed after every tenth, hundredth or thousandth detected photon (e.g., after every tenth, hundredth or thousandth histogram update), without limiting the disclosure to these numbers. A number of detected photons after which a histogram check is performed may be constant or may be adapted based on the histogram, e.g., based on a number of photons that have already been detected and/or on a SBR or SNR of the histogram. For example, the histogram check may be performed more frequently for a histogram with a higher SBR or SNR than for a histogram with a lower SBR or SNR.

In some embodiments, the histogram check is performed before a repeated emission of the light signal (laser dot, laser pulse), and the repeated light signal may be emitted only if a peak has not yet been detected in a histogram of a pixel (photosensitive element) that receives a reflection of the light signal.

In some embodiments, smart ways for determining a frequency of a histogram check are employed. For example, the histogram check may be performed only when new detected photons fall into a histogram bin that corresponds to a possible signal peak, e.g., when new detected photons correspond to a histogram bin with a highest photon count among the plurality of histogram bins of the histogram. A maximum bin (histogram bin with a highest photon count) may be tracked as follows:

For tracking of the maximum bin, an additional memory address may be provided in each histogram block (e.g., in a histogram memory or in a maximum register of the histogram block). The additional memory address may store the maximum bin address number and the maximum bin photon count. As the histogram is integrated, if a bin count overtakes the count of the maximum bin, a maximum bin memory (e.g., a maximum register) may be overwritten with a new value that indicates a new maximum bin photon count and, as necessary, a new maximum bin address number. An example of tracking the maximum bin is described above in the sections that correspond to FIG. 2 and FIG. 4 with respect to the maximum register 15b.

In some embodiments, a synchronous scan of histogram bins (loop around histogram) is performed to detect a peak and compute a background level in a same loop.

Options for determining and/or processing background bins (i.e., histogram bins that correspond to a background signal) for calculating a background level b of the histogram include the following options:

In some embodiments, the peak detection unit 15d and/or the peak detection at S35 scans histogram bins and performs a low-pass filtering to find an average background level b.

In some embodiments, the peak detection unit 15d and/or the peak detection at S35 selects and averages a cluster of background bins around the maximum bin(s) for determining an average background level b.

Options for determining which histogram bins that possibly correspond to a detected signal (peak) to compare to a peak criterion (e.g., to the peak threshold th for detecting a peak) include the following options:

In some embodiments, a maximum bin count only (e.g. a highest photon count among the plurality of histogram bins) is compared to the peak criterion (e.g., to the peak threshold th).

In some embodiments where a detected peak includes more than one histogram bin (e.g., corresponding to a duration of a laser pulse), a mean of photon counts of histogram bins that correspond to a (possible) peak or peak candidate is calculated and compared to the peak criterion (e.g., to the peak threshold th).

In some embodiments, the histogram is scanned for multiple peaks. For example, if an integration of incident light and an updating of the histogram is interrupted as soon as a strongest (e.g., highest) peak is detected in the interval, other (e.g., lower) peaks might not have a chance to form. Therefore, the background level may be set by a low-pass filter of photon counts as the histogram bins are scanned. Multiple thresholds may be provided for detecting peak candidates that correspond to second and third peaks in the histogram that might still be forming, for example, by using a different sigma o (standard deviation, e.g., 2σ, 3σ, 4σ, . . . ) above the background level to calculate the peak threshold th. If a peak candidate that corresponds to a second, third, . . . peak is detected at a lower threshold, a peak detection unit and/or a peak detection may wait for a configurable interval (e.g., N more histogram scan loops or histogram updates) before raising an interrupt for disabling an integration of incident light by a pixel (photosensitive element) and for disabling an emission of a light signal (laser dot, laser pulse) by a VCSEL. An example of scanning the histogram for multiple peaks is described above in the sections that correspond to FIG. 2 and FIG. 4 with respect to the peak detection unit 15d and to the peak candidate detection at S36.

Some embodiments may provide some or all of the following advantages with respect to other solutions, which have previously been existing.

Some embodiments provide a high dynamic (distance) range with low power consumption: Pixels (photosensitive elements) that converge on a peak with a low number of repetitions (usually higher power because of higher photon rate) may be disabled and stop consuming power early in a (time) frame.

In some embodiments, a peak threshold is adaptive. A duty cycle of a pixel (photosensitive element) and of a laser dot (VCSEL) may depend on each respective individual pixel histogram response rather than on a global threshold or exposure.

Some embodiments provide a smart illuminator. Emitter dots (VCSELs) (which, in some embodiments, are a main contributor to power consumption in a DTOF system) may be driven only for a required time (duty cycle) depending on a spatial (pixel) response.

In the following, examples of application of an imaging sensor and/or of an imaging method according to the disclosure are provided.

The technology according to an embodiment of the present disclosure is applicable to various products. For example, the technology according to an embodiment of the present disclosure may be implemented as a device included in a mobile device, e.g., a smartphone, smart glasses, a head-mounted display, a smartwatch, a mobile phone, a mobile tablet, a notebook, a terminal device or the like.

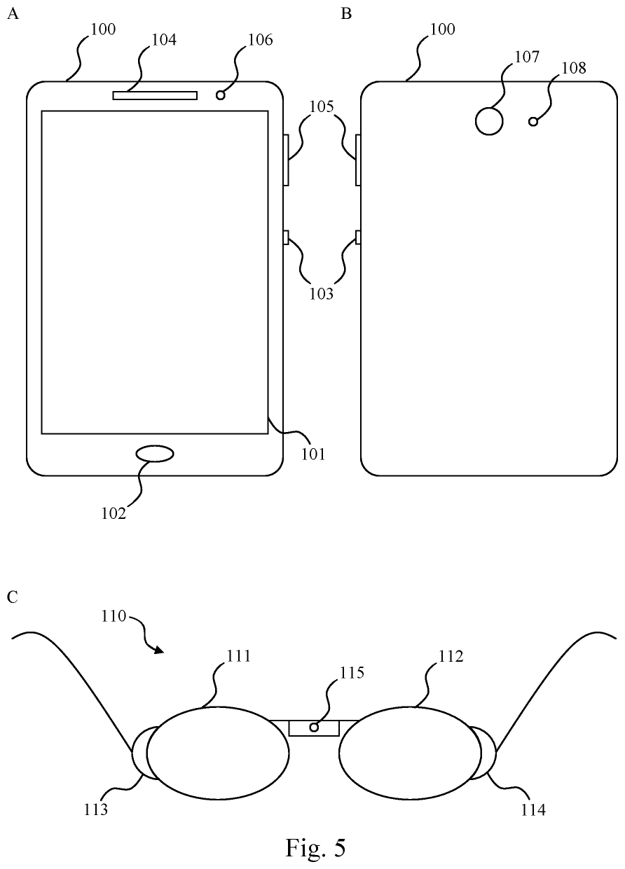

FIG. 5 illustrates an embodiment of a smartphone 100 and of smart glasses 110.

A of FIG. 5 shows a front side of the smartphone 100. The smartphone 100 includes a touchscreen 101, a home button 102, a power button 103, a loudspeaker 104, a volume button 105 and a first imaging sensor 106.

The touchscreen 101 displays visual content to a user and receives touch input from the user. The home button 102 receives an input from the user. By pressing the home button 102, the user can cause a home screen to be displayed on the touchscreen 101. The power button 103 receives an input from the user. By pressing the power button 103 for a short time (e.g., shorter than a second, without limiting the disclosure thereto), the user can cause the touchscreen 101 to be switched on if the touchscreen 101 is off and to be switched off if the touchscreen 101 is on. By pressing the power button 103 for a longer time (e.g., longer than two seconds, without limiting the disclosure thereto), the user can cause the smartphone 100 to be switched on if the smartphone 100 is off and to be switched off if the smartphone 100 is on. The loudspeaker 104 outputs audio content including music and speech to the user. The volume button 105 receives input from the user. By pressing an upper portion of the volume button 105, the user can increase a volume of the sound output by the loudspeaker 104. By pressing a lower portion of the volume button 105, the user can decrease a volume of the sound output by the loudspeaker 104.

The first imaging sensor 106 is configured like the imaging sensor 10 of FIG. 2 and performs direct time-of-flight (DTOF) measurements according to the method 30 of FIG. 4. The first imaging sensor 106 detects, based on the DTOF measurements, whether the user is present in front of the smartphone 100. If the first imaging sensor 106 detects that the presence of the user changes from the user not being present in front of the smartphone 100 to the user being present within a predetermined range in front of the smartphone 100, the first imaging sensor 106 causes the touchscreen 101 to be switched on. The first imaging sensor 106 senses, based on the DTOF measurements, a three-dimensional (3D) shape of a face of the user and authenticates the user based on the 3D shape of his face. If the first imaging sensor 106 authenticates the user when the touchscreen 101 is displaying a lock screen, the first imaging sensor 106 causes the lock screen to be unlocked. The first imaging sensor 106 detects, based on the DTOF measurements, an object in close proximity to the front side of the smartphone 100, e.g., if the smartphone 100 is put into a bag or laid down on a table with the front side facing downwards. If the first imaging sensor 106 detects an object in close proximity of the front side of the smartphone 100, the first imaging sensor 106 causes the touchscreen 101 to be switched off for saving electrical energy.

B of FIG. 5 shows a back side of the smartphone 100. The smartphone 100 includes a camera 107 and a second imaging sensor 108.

The camera 107 captures visual content such as photos and movies. The camera 107 has an aperture that is large enough such that the camera 107 receives sufficient light for capturing photos and movies that comply with a desired image quality. The camera 107 further has a lens adjustable by an autofocus function for acquiring a sharp image of an object at one of various distances from the camera 107.

The second imaging sensor 108 is configured like the imaging sensor 10 of FIG. 2 and performs DTOF measurements according to the method 30 of FIG. 4. The second imaging sensor 108 determines, based on the DTOF measurements, a distance of an object from the camera 107 and provides the determined distance to the autofocus function such that the autofocus function can adjust the lens for acquiring, with the camera 107, a sharp image of the object. The second imaging sensor 108 generates, based on the DTOF measurements, a 3D map of an environment of the smartphone 100 for a mapping application that generates a map of the environment, for a navigation application that navigates the user through a known environment and for an augmented reality application that controls display of a virtual object on the touchscreen 101, including a size, a position and a perspective of the virtual object as well as an overlap of the virtual object with a real object. The second imaging sensor 108 generates, based on the DTOF measurements, a 3D representation of an object in the standard tessellation language (STL) format for replicating the object with a 3D printer.

C of FIG. 5 shows smart glasses 110. The smart glasses 110 include a right glass 111, a left glass 112, a right eye-tracking and display unit 113, a left eye-tracking and display unit 114 and an imaging sensor 115.

When a user is wearing the smart glasses 110, the right glass 111 is positioned in front of a right eye of the user such that light incident from an environment into the right eye passes through the right glass 111. Likewise, when the user is wearing the smart glasses 110, the left glass 112 is positioned in front of a left eye of the user such that light incident from the environment into the left eye passes through the left glass 112. The right glass 111 and the left glass 112 each include a waveguide and a holographic optical element (HOE). The waveguide leads, based on total internal reflection, a light signal representing a virtual object to the respective HOE. The HOE extracts, based on Bragg reflection, the light signal from the waveguide and reflects the light signal to the respective right or left eye of the user, thus allowing the user to see the virtual object represented by the light signal.

The right eye-tracking and display unit 113 and the left eye-tracking and display unit 114 each include a microdisplay that generates and emits the respective light signal representing the virtual object and an optical means (e.g., lens, mirror, grating) that couples the light signal into the waveguide of the respective right or left glass 111 or 112. Further, the right eye-tracking and display unit 113 and the left eye-tracking and display unit 114 each include a camera that tracks a line-of-sight of the respective right or left eye of the user wearing the smart glasses 110 for determining a position on the respective right or left glass 111 or 112 where the virtual object should be displayed and for receiving a user input based on a gaze of the user, e.g., based on determining that a menu item displayed as a virtual object is intersected by the line-of-sight of the user.

The imaging sensor 115 is configured like the imaging sensor 10 of FIG. 2 and performs DTOF measurements according to the method 30 of FIG. 4. The imaging sensor 115 generates, based on the DTOF measurements, a 3D map of an environment of the smart glasses 110 for a mapping application that generates a map of the environment, for a navigation application that navigates the user through a known environment and for an augmented reality application that controls display of a virtual object on the right or left glass 111 or 112 by the right eye-tracking and display unit 113 or the left eye-tracking and display unit 114, respectively, including a size, a position and a perspective of the virtual object as well as an overlap of the virtual object with a real object seen by the user through the right and/or left glass 111 or 112.

By performing DTOF measurements according to the method 30 of FIG. 4, the first imaging sensor 106, the second imaging sensor 108 and the imaging sensor 115 of FIG. 5 consume less electrical power than a conventional DTOF imaging sensor in some instances. Since a size of the smartphone 100 and of the smart glasses 110 limits a size (and, thus, an amount of stored energy) of a battery of the smartphone 100 and of the smart glasses 110, respectively, performing the DTOF measurements according to the method 30 of FIG. 4 allows operating the smartphone 100 or smart glasses 110, respectively, for a longer time without recharging the battery.

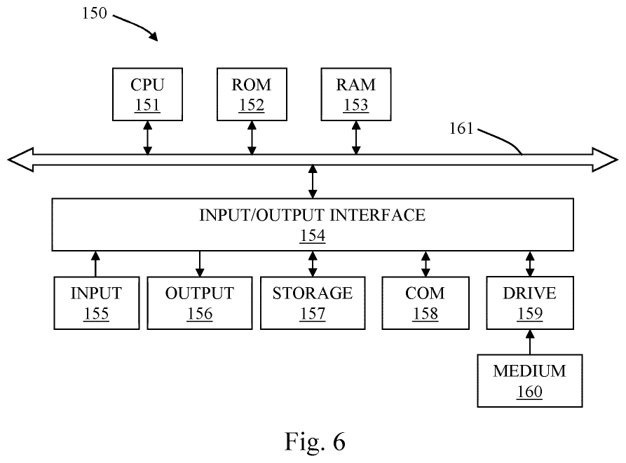

Note that, in some embodiments, the first imaging sensor 106, the second imaging sensor 108 and the imaging sensor 115 of FIG. 5 include a general-purpose computer such as the computer 150 of FIG. 6.

FIG. 6 illustrates an embodiment of a general-purpose computer 150. The computer 150 can be implemented such that it can basically function as any type of mobile device, for example, a smartphone (e.g., the smartphone 100 of FIG. 5), smart glasses (e.g., the smart glasses 110 of FIG. 5), a head-mounted display, a smartwatch, a mobile phone, a mobile tablet, a notebook, a terminal device or the like. The computer has components 151 to 161, which can form a circuitry, such as any one of the imaging sensor 10, the pixel array 11, the TDC bank 12, the histogram block unit 13, the emitter VCSEL array IC 14 and/or the histogram block 15, as described herein.

Embodiments which use software, firmware, programs or the like for performing the methods as described herein can be installed on computer 150, which is then configured to be suitable for the concrete embodiment.

The computer 130 has a CPU 151 (Central Processing Unit), which can execute various types of procedures and methods as described herein, for example, in accordance with programs stored in a read-only memory (ROM) 152, stored in a storage 157 and loaded into a random-access memory (RAM) 153, stored on a medium 160 which can be inserted in a respective drive 159, etc.

The CPU 151, the ROM 152 and the RAM 153 are connected with a bus 161, which in turn is connected to an input/output interface 154. The number of CPUs, memories and storages is only exemplary, and the skilled person will appreciate that the computer 150 can be adapted and configured accordingly for meeting specific requirements which arise, when it functions as a base station or as user equipment (end terminal).

At the input/output interface 154, several components are connected: an input 155, an output 156, the storage 157, a communication interface 158 and the drive 159, into which a medium 160 (compact disc, digital video disc, compact flash memory, or the like) can be inserted.

The input 155 can be a pointer device (mouse, graphic table, or the like), a keyboard, a microphone, a camera, a touchscreen, an eye-tracking unit etc.

The output 156 can have a display (liquid crystal display, cathode ray tube display, light emittance diode display, etc.; e.g., included in a touchscreen), loudspeakers, etc.

The storage 157 can have a hard disk, a solid-state drive, a flash drive and the like.

The communication interface 158 can be adapted to communicate, for example, via a local area network (LAN), wireless local area network (WLAN), mobile telecommunications system (GSM, UMTS, LTE, NR etc.), Bluetooth, near-field communication (NFC), infrared, etc.

It should be noted that the description above only pertains to an example configuration of computer 150. Alternative configurations may be implemented with additional or other sensors, storage devices, interfaces or the like. For example, the communication interface 158 may support other radio access technologies than the mentioned UMTS, LTE and NR.

For example, the technology according to an embodiment of the present disclosure may be implemented as a device included in a mobile body that is any of kinds of automobiles, electric vehicles, hybrid electric vehicles, motorcycles, bicycles, personal mobility vehicles, airplanes, drones, ships, robots, construction machinery, agricultural machinery (tractors), and the like.

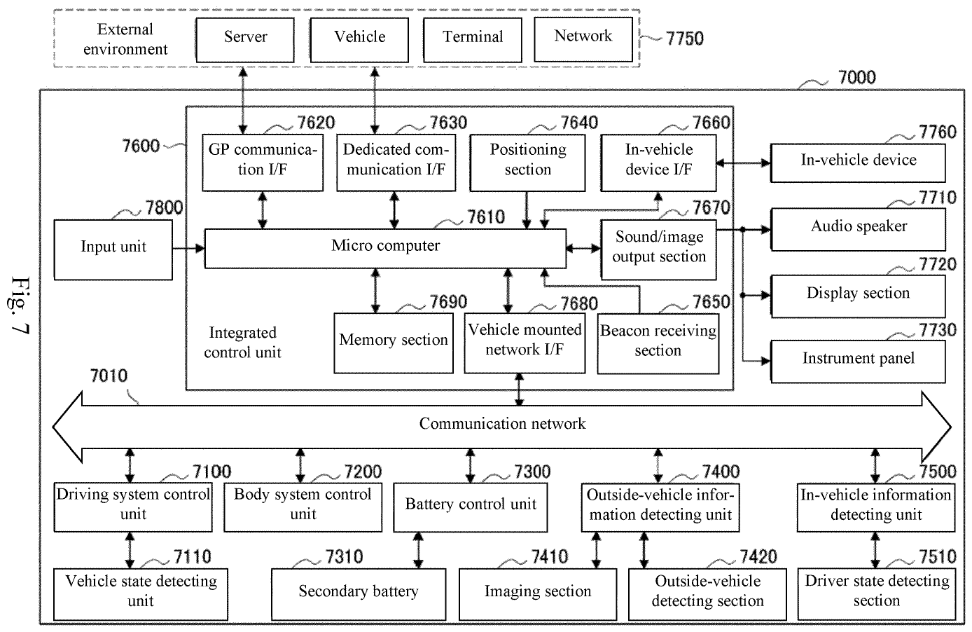

FIG. 7 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 7, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 7 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

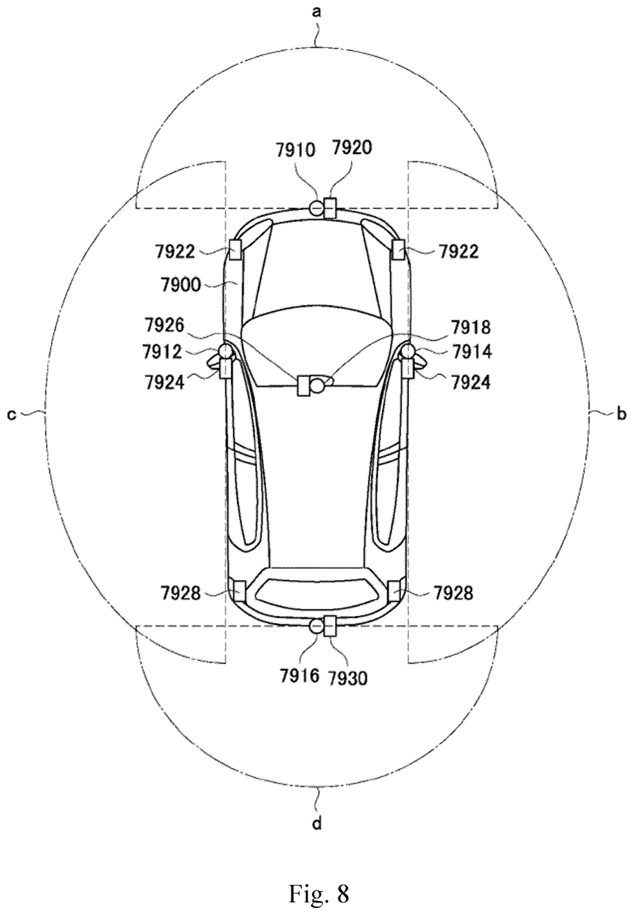

FIG. 8 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 8 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 7, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 7, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 7 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for realizing the functions of the information processing device 100 according to the present embodiment described with reference to FIG. 7 can be implemented in one of the control units or the like. In addition, a computer readable recording medium storing such a computer program can also be provided. The recording medium is, for example, a magnetic disk, an optical disk, a magneto-optical disk, a flash memory, or the like. In addition, the above-described computer program may be distributed via a network, for example, without the recording medium being used.

It should be recognized that the embodiments describe methods with an exemplary ordering of method steps. The specific ordering of method steps is however given for illustrative purposes only and should not be construed as binding. Changes of the ordering of method steps may be apparent to the skilled person.

It should also be noted that the division of the control or circuitry 7600 of FIG. 7 into units 7610 to 7690 is only made for illustration purposes, and that the present disclosure is not limited to any specific division of functions in specific units. For instance, at least parts of the circuitry could be implemented by a respective programmed processor, field programmable gate array (FPGA), dedicated circuits, and the like.

Further, the division of the imaging sensor 10 of FIG. 2 into units 11 to 14, the division of the histogram block unit 13 into histogram blocks (including the histogram block 15), the division of the histogram block 15 into units 15a to 15d and the division of the emitter VCSEL array IC 14 into units 14a and 14c is only made for illustration purposes, and the present disclosure is not limited to any specific division of functions in specific units. The units may be divided into separate units and/or merged into combined units in any suitable manner. In some embodiments, the histogram block 15 may receive and process timestamped photon events from several or all pixels of the pixel array 11. In some embodiments, the histogram memory 15b may be provided separately from the histogram block 15 and may store histograms 15e of a plurality of histogram blocks 15. In some embodiments, the peak detection unit 15d may be provided separately from the histogram block 15 and may analyze, for detecting a peak, histograms 15e of a plurality of histogram blocks 15. Further alterations of the division of the imaging sensor 10 into units may be apparent to the skilled person.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An imaging sensor, comprising:
a photosensitive element configured to integrate incident light and stop the integration of incident light when a signal is detected in the incident light integrated by the photosensitive element.

(2) The imaging sensor of (1), further comprising:
a light emission unit configured to emit a light signal into a scene;
wherein the incident light includes light reflected from the scene; and
wherein the detected signal corresponds to a reflection of the light signal from the scene.

(3) The imaging sensor of (2), wherein the light emission unit is further configured to stop emitting the light signal when the signal is detected in the incident light integrated by the photosensitive element.

(4) The imaging sensor of any one of (1) to (3),
wherein the integration includes detecting single photons of the incident light; and
wherein the signal is detected based on timestamps of detection of the single photons.

(5) The imaging sensor of (4), further comprising:
a histogram unit configured to generate, based on the timestamps of detection of the single photons, a histogram that indicates a count of detected single photons in each of a plurality of time intervals; and
a peak detection unit configured to detect, in the histogram, a peak that indicates the detected signal.

(6) The imaging sensor of (5), wherein the detecting of the peak includes determining that the count of detected single photons in a time interval of the plurality of time intervals exceeds a predetermined threshold.

(7) The imaging sensor of (6),
wherein the predetermined threshold is based on a background level.

(8) The imaging sensor of (7), wherein the peak detection unit is configured to determine the background level based on low-pass filtering of counts of detected single photons in the plurality of time intervals.

(9) The imaging sensor of (7) or (8), wherein the peak detection unit is configured to determine the background level based on counts of detected single photons in a cluster of time intervals, of the plurality of time intervals, that correspond to the background signal.

(10) The imaging sensor of any one of (7) to (9), wherein the peak detection unit is further configured to analyze the histogram for detecting the peak and determine the background level during a same loop through the plurality of time intervals.

(11) The imaging sensor of any one of (6) to (10), wherein the peak detection unit is configured to analyze the histogram for detecting the peak when the photosensitive element detects a single photon that corresponds to a time interval with a highest count of detected single photons among the plurality of time intervals.

(12) The imaging sensor of (11), wherein the histogram unit further includes a maximum register that indicates the time interval with the highest count of detected single photons and the corresponding count of detected single photons.

(13) The imaging sensor of any one of (5) to (12), wherein the peak detection unit is further configured to detect, in the histogram, a peak candidate that is lower than the detected peak and cause the photosensitive element to continue the integration after detecting the peak.

(14) The imaging sensor of any one of (1) to (13), further comprising:
a further photosensitive element configured to integrate incident light and continue the integration of incident light when the photosensitive element stops the integration of incident light if no signal is detected in the incident light integrated by the further photosensitive element.

(15) An imaging method for imaging with the imaging sensor of any one of (1) to (14), the imaging method comprising:
integrating incident light; and
stopping the integration of incident light when a signal is detected in the integrated incident light.

(16) A computer program comprising program code causing a computer to perform the method according to (15), when being carried out on a computer.

(17) A non-transitory computer-readable recording medium that stores therein a computer program product, which, when executed by a processor, causes the method according to (15) to be performed.

1. An imaging sensor, comprising:
a photosensitive element configured to integrate incident light and stop the integration of incident light when a signal is detected in the incident light integrated by the photosensitive element.

2. The imaging sensor of claim 1, further comprising:
a light emission unit configured to emit a light signal into a scene;
wherein the incident light includes light reflected from the scene; and
wherein the detected signal corresponds to a reflection of the light signal from the scene.

3. The imaging sensor of claim 2, wherein the light emission unit is further configured to stop emitting the light signal when the signal is detected in the incident light integrated by the photosensitive element.

4. The imaging sensor of claim 1,
wherein the integration includes detecting single photons of the incident light; and
wherein the signal is detected based on timestamps of detection of the single photons.

5. The imaging sensor of claim 4, further comprising:
a histogram unit configured to generate, based on the timestamps of detection of the single photons, a histogram that indicates a count of detected single photons in each of a plurality of time intervals; and
a peak detection unit configured to detect, in the histogram, a peak that indicates the detected signal.

6. The imaging sensor of claim 5, wherein the detecting of the peak includes determining that the count of detected single photons in a time interval of the plurality of time intervals exceeds a predetermined threshold.

7. The imaging sensor of claim 6,
wherein the predetermined threshold is based on a background level.

8. The imaging sensor of claim 7, wherein the peak detection unit is configured to determine the background level based on low-pass filtering of counts of detected single photons in the plurality of time intervals.

9. The imaging sensor of claim 7, wherein the peak detection unit is configured to determine the background level based on counts of detected single photons in a cluster of time intervals, of the plurality of time intervals, that correspond to the background signal.

10. The imaging sensor of claim 7, wherein the peak detection unit is further configured to analyze the histogram for detecting the peak and determine the background level during a same loop through the plurality of time intervals.

11. The imaging sensor of claim 6, wherein the peak detection unit is configured to analyze the histogram for detecting the peak when the photosensitive element detects a single photon that corresponds to a time interval with a highest count of detected single photons among the plurality of time intervals.

12. The imaging sensor of claim 11, wherein the histogram unit further includes a maximum register that indicates the time interval with the highest count of detected single photons and the corresponding count of detected single photons.

13. The imaging sensor of claim 5, wherein the peak detection unit is further configured to detect, in the histogram, a peak candidate that is lower than the detected peak and cause the photosensitive element to continue the integration after detecting the peak.

14. The imaging sensor of claim 1, further comprising:
a further photosensitive element configured to integrate incident light and continue the integration of incident light when the photosensitive element stops the integration of incident light if no signal is detected in the incident light integrated by the further photosensitive element.

15. An imaging method for imaging with the imaging sensor of claim 1, the imaging method comprising:
integrating incident light; and
stopping the integration of incident light when a signal is detected in the integrated incident light.
